(19) United States
(12) Patent Application Publication
(10) Pub. No.: US 2024/0046141 A1
(43) Pub. Date: Feb. 8, 2024

(54) METHOD FOR GENERATING DATA USING MACHINE LEARNING AND COMPUTING DEVICE FOR EXECUTING THE SAME

(71) Applicant: DEEPBRAIN AI INC., Seoul (KR)

(72) Inventors: Gyeong Su CHAE, Seoul (KR); Guem Buel HWANG, Seoul (KR); Sung Woo PARK, Seoul (KR)

(21) Appl. No.: 17/764,265

(22) PCT Filed: Jun. 17, 2021
(86) PCT No.: PCT/KR2021/007631

§ 371 Date: Mar. 28, 2022

(30) Foreign Application Priority Data
Apr. 29, 2021 (KR) 10-2021-0055549

(51) Int. Cl. G06N 20/00

(52) U.S. Cl. CPC G06N 20/00

(57) ABSTRACT

A computing device according to an embodiment disclosed is provided with one or more processors and a memory storing one or more programs executed by the one or more processors. The computing device includes a machine learning model, in which the machine learning model is trained to perform a task of receiving data in which a part of original data is damaged or removed, and restoring and outputting the damaged or removed data part as a main task, and is trained to perform a task of receiving original data and reconstructing and outputting the received original data as an auxiliary task.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2021/007631, filed Jun. 17, 2021, which claims priority to the benefit of Korean Patent Application No. 10-2021-0055549 filed on Apr. 29, 2021 the entirety the entire contents of which are incorporated herein by reference.

### BACKGROUND

### 1. Technical Field

Embodiments of the present invention relate to a technique for generating data using machine learning.

### 2. Background Art

In a machine learning model that performs a task of restoring a damaged or removed part of data (e.g., a task of restoring partially damaged data, a task of inpainting an image, a task of synthesizing a lip sync image that fills in an uttering part hidden in a face image to match a speech signal, etc.), when data of which a part is damaged or removed is input, information of the part is estimated from information of another part existing in the input data and restored. In this task, when training the machine learning model, training is performed so that data of which a part is damaged or removed is input and an error between data output from the machine learning model and original data is reduced.

For example, when the machine learning model performs the task of restoring the appearance of a mask-covered part in order to recognize an individual's face in a face image where the nose, mouth, chin, etc. are covered by wearing a mask to prevent coronavirus, etc., the structure, position, shape, color, and texture of a face part covered by the mask should be predicted based on the position, shape, color, texture, curve of the mask, etc., of an exposed part of the face.

In this case, when the location or pattern of a part of which data needs to be restored is very diverse (e.g., when restoring damaged parts of an image that contains various objects such as people, objects, landscapes, etc.), or when detailed information of the part to be restored is not present in another part or the detailed information is difficult to infer from another part (e.g., a lip part of the face needs to be restored, but a part having a shape and color similar to the lips is not present in other parts of the face), it is difficult to accurately restore the part to be restored.

Meanwhile, this problem also occurs in machine learning models (e.g., a speech synthesis model that receives text and converts it into a speech spectrogram or waveform, a lip sync image synthesis model that generates a face image by receiving speech as an input or fills in an uttering part of a face image, a model that receives random numbers following a normal distribution and generates data with a specific pattern such as an image or speech, etc.) that perform transformations between different types of data.

For example, in the case of a speech synthesis model that outputs spoken speech by using text as input, input text should be transformed into a completely different type of speech information. In this case, the text, which is input data, is relatively simple and the amount of information is small compared to the speech, which is output data. That is, it may be difficult to reconstruct detailed information of the output data from the input data because the text is only related to a simple pattern of the speech signal and does not include detailed information such as actual frequency components and overtone structures.

### SUMMARY

Embodiments of the present invention are to provide a method for generating data of using machine learning capable of precisely restoring or reconstructing data, and a computing device for executing the same.

A computing device according to an embodiment disclosed is a computing device provided with one or more processors and a memory storing one or more programs executed by the one or more processors, the computing device including a machine learning model, in which the machine learning model is trained to perform a task of receiving data in which a part of original data is damaged or removed, and restoring and outputting the damaged or removed data part as a main task, and is trained to perform a task of receiving original data and reconstructing and outputting the received original data as an auxiliary task.

The machine learning model may include an encoder that extracts a first feature vector by using data in which a part of the original data is damaged or removed as input when learning the main task, and extracts a second feature vector by using the original data as input when learning the auxiliary task, and a decoder that outputs restored data based on the first feature vector input from the encoder when learning the main task, and outputs reconstructed data based on the second feature vector input from the encoder input when learning the auxiliary task.

The machine learning model for the main task may be expressed by Equation 1 below, and an objective function Lᵣₑₛₜₒᵣₐₜᵢₒₙ for performing the main task may be expressed by Equation 2 below.

\hat{X}_{Y}=D(E(Y;α);β) (Equation 1)

Lᵣₑₛₜₒᵣₐₜᵢₒₙ=∥X−\hat{X}_{Y}∥ (Equation 2)
X: original data
Y: data in which part of original data has been damaged or removed
\hat{X}_{Y}: restored data
E: neural network constituting encoder
α: weight of the neural network constituting encoder
D: neural network that constituting decoder
β: weight of neural network constituting decoder

The machine learning model for the auxiliary task may be expressed by Equation 3 below, and an objective function L_{reconstruction} for performing the auxiliary task may be expressed by Equation 4 below.

\hat{X}_{X}=D(E(X;α);β) (Equation 3)

L_{reconstruction}=∥X−\hat{X}_{X}∥ (Equation 4)
\hat{X}_{X}: reconstructed data

Optimized weights (α*,β*) of the machine learning model for performing both the main task and the auxiliary task may be expressed through Equation 5 below.

α*,β*=argmin_{α,β}(Lᵣₑₛₜₒᵣₐₜᵢₒₙ+λL_{reconstruction}) (Equation 5)
λ: weight for importance between objective function of main task and objective function of auxiliary task

The machine learning model may adjust a ratio of the number of learning times of the main task and the auxiliary task so that a sum of the objective function of the main task and the objective function of the auxiliary task is minimized.

A computing device according to another embodiment disclosed is a computing device provided with one or more processors and a memory storing one or more programs executed by the one or more processors, the computing device including a machine learning model, in which the machine learning model is trained to perform a task of receiving a first type of data, and transforming and outputting the first type of data into a second type of data that is different from the first type as a main task, and is trained to perform a task of receiving a second type of data, which is the same type as that output from the main task, and reconstructing and outputting the received second type of data as an auxiliary task.

The machine learning model may include a first encoder that extracts a first feature vector by using the first type of data as input when learning the main task, a second encoder that extracts a second feature vector by using the second type of data as input when learning the auxiliary task, and a decoder that outputs transformed data based on the first feature vector input from the first encoder when learning the main, and outputs reconstructed data based on the second feature vector input from the second encoder input when learning the auxiliary task.

The machine learning model for the main task may be expressed by Equation 6 below, and an objective function L_{transformation} for performing the main task may be expressed by Equation 7 below.

\hat{X}_{Y}=D(E₁(Y;α);β) (Equation 6)

L_{transformation}=∥X−\hat{X}_{X}∥ (Equation 7)
X: second type of data
Y: first type of data
\hat{X}_{Y}: transformed data
E₁: neural network constituting first encoder
α: weight of neural network constituting first encoder
D: neural network constituting decoder
β: weight of neural network constituting decoder

The machine learning model for the auxiliary task may be expressed by Equation 8 below, and an objective function L_{reconstruction} for performing the auxiliary task may be expressed by Equation 9 below.

\hat{X}_{X}=D(E₂(X;γ);β) (Equation 8)

L_{reconstruction}=∥X−\hat{X}_{X}∥ (Equation 9)
E₂: neural network constituting second encoder
γ: weight of neural network constituting second encoder
\hat{X}_{X}: reconstructed data

Optimized weights (α*, β*, γ*) of the machine learning model for performing both the main task and the auxiliary task may be expressed through Equation 10 below.

α*,β*,γ*=argmin_{α,β,γ}(L_{transformation}+λL_{reconstruction}) (Equation 10)
λ: weight for importance between objective function of main task and objective function of auxiliary task

The machine learning model may adjust a ratio of the number of times of learning times of the main task and the auxiliary task so that a sum of the objective function of the main task and the objective function of the auxiliary task is minimized.

A method of generating data using machine learning according to an embodiment disclosed is a method performed in a computing device provided with one or more processors and a memory storing one or more programs executed by the one or more processors, the method including an operation of being trained to perform a task of receiving data in which a part of original data is damaged or removed, and restoring and outputting the damaged or removed data part as a main task, in the machine learning model, and an operation of being trained to perform a task of receiving original data and reconstructing and outputting the received original data as an auxiliary task, in the machine learning model.

A method of generating data using machine learning according to another embodiment disclosed is a method performed in a computing device provided with one or more processors and a memory storing one or more programs executed by the one or more processors, the method including an operation of being trained to perform a task of receiving a first type of data, and transforming and outputting the first type of data into a second type of data that is different from the first type as a main task, in the machine learning model, and an operation of being trained to perform a task of receiving a second type of data, which is the same type as that output from the main task, and reconstructing and outputting the received second type of data as an auxiliary task, in the machine learning model.

According to the disclosed embodiment, in a machine learning model whose main task is to receive data of which a part is damaged or removed and to restore the damaged or removed data part from the input data, by additionally performing the auxiliary task of receiving original data as input, and reconstructing and outputting the input original data in the same form, weights of the neural network constituting the machine learning model perform forward operations in the auxiliary task even on damaged or removed data, and thus more effective training is achieved compared to performing only the main task.

In addition, in a machine learning model whose main task is to receive a first type of data, transform the first type of data to a second type of data, and output the second type of data, forward computation can be performed even on the second type of data to adjust the weights of the corresponding neural network by additionally performing an auxiliary task of receiving the second type of data, reconstructing and outputting the second type of data in the same form as the input second type of data, so that even detailed parts that are difficult to reproduce only by performing the main task can be finely transformed.

### BRIEF DESCRIPTION OF THE DRAWINGS

FIG. 1 is a diagram schematically illustrating a device for generating data according to an embodiment of the present invention.

FIG. 2 is a diagram schematically illustrating a neural network for performing a main task and an auxiliary task of the device for generating data according to an embodiment of the present invention.

FIG. 3 is a diagram schematically illustrating a device for generating data according to another embodiment of the present invention.

FIG. 4 is a diagram schematically illustrating a neural network for performing a main task and an auxiliary task of the device for generating data according to another embodiment of the present invention.

FIG. 5 is a block diagram illustratively describing a computing environment including a computing device suitable for use in exemplary embodiments.

### DETAILED DESCRIPTION

Hereinafter, a specific embodiment of the present invention will be described with reference to the drawings. The following detailed description is provided to aid in a comprehensive understanding of the methods, apparatus and/or systems described herein. However, this is illustrative only, and the present invention is not limited thereto.

In describing the embodiments of the present disclosure, when it is determined that a detailed description of related known technologies related to the present invention may unnecessarily obscure the subject matter of the present invention, a detailed description thereof will be omitted. In addition, terms to be described later are terms defined in consideration of functions in the present invention, which may vary according to the intention or custom of users or operators. Therefore, the definition should be made based on the contents throughout this specification. The terms used in the detailed description are only for describing embodiments of the present invention, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

In addition, terms such as the first and second may be used to describe various components, but the components should not be limited by the terms. The above terms may be used for the purpose of distinguishing one component from another component. For example, without departing from the scope of the present invention, a first component may be referred to as a second component, and similarly, the second component may also be referred to as the first component.

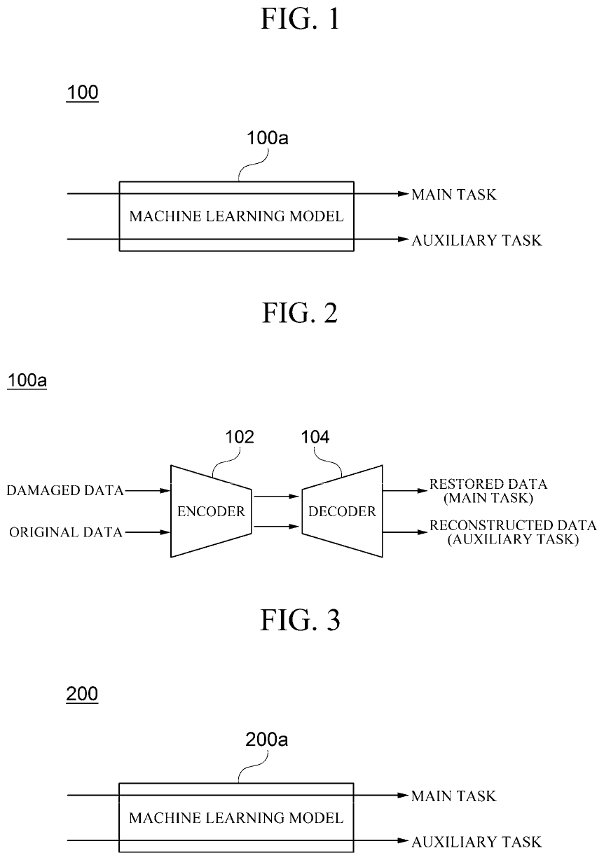

FIG. 1 is a diagram schematically illustrating a device for generating data according to an embodiment of the present invention.

Referring to FIG. 1, a device for generating data 100 includes a machine learning model 100a. The machine learning model 100a is trained to receive data in which a part of original data is damaged or removed, and to restore the damaged or removed data part from the input data. In this case, the machine learning model 100a may be trained so that a difference between the data restored by the machine learning model 100a (restored data) and the original data is minimized.

The machine learning model 100a may perform a task of receiving data in which a part of data is damaged or removed, and restoring the damaged or removed data part from the input data as a main task. In addition, the machine learning model 100a may perform an auxiliary task in addition to the main task. The machine learning model 100a may perform a task of receiving original data as input and reconstructing and outputting the input original data in the same form as an auxiliary task. That is, the machine learning model 100a may perform an autoencoding task as the auxiliary task.

In other words, the machine learning model 100a may be trained to perform the main task of receiving data in which a part of the original data is damaged or removed and restoring the damaged or removed data part from the input data, and perform the auxiliary task of receiving original data and reconstructing and outputting the inputted original data.

In this case, the machine learning model 100a trains the weights through back propagation of an error between the original data and the restored data output from the machine learning model 100a when learning the main task in the neural network. That is, in a case where the machine learning model 100a learns the main task, when a part of data in which the original data is damaged or removed is restored, the weights of the neural network are adjusted by learning an error between the restored data and the original data through backpropagation.

On the other hand, when the machine learning model 100a performs the auxiliary task, the original data itself is used as input data to output the reconstructed data in the same form as the original data. In this case, the weights of the neural network perform forward operations in the auxiliary task even on the damaged or removed part in the main task, and thus when additionally performing the auxiliary task, more effective training is achieved compared to performing only the main task.

That is, since the damaged or removed part in the main task is input as being included in the input data in the auxiliary task (original data itself is input), the process of extracting features (forward operation) is performed in the auxiliary task even for the damaged or removed part in the main task and the weights of the neural network are trained through this process, more effective training is achieved compared to training the weights of the neural network only through backpropagation by the main task. As a result, it is possible to precisely restore the damaged or removed part that was difficult to restore only by training through the main task.

For example, when the machine learning model 100a learns the main task of restoring the part in which a jaw area is hidden from a face image in which the jaw area is covered, the machine learning model 100a outputs a restored image by attempting to fill in the shape and color of the corresponding part in a state in which image features of the part (mouth, chin, etc.) where the jaw area is covered are not extracted from the input face image. Then, the machine learning model 100a trains the weights of the neural network through backpropagation with respect to the error between the reconstructed image and the original image.

In this case, if the machine learning model 100a receives the same face image in which the jaw area is not covered, extracts the image features from the input face image (in the main task, image features are also extracted from the part where the jaw area is covered), and then additionally performs an auxiliary task of outputting a reconstructed image reconstructed from the input image, the forward operation of extracting the image features is performed even for the part where the jaw area is covered, and thus the purpose that was intended to be performed through the main task (i.e., the purpose of restoring the part where the jaw area is covered) can be performed more effectively.

FIG. 2 is a diagram schematically illustrating a neural network for performing a main task and an auxiliary task of the device for generating data according to an embodiment of the present invention.

Referring to FIG. 2, the machine learning model 100a may include an encoder 102 and a decoder 104. In an exemplary embodiment, the machine learning model 100a may be a convolutional neural network (CNN)-based machine learning model, but is not limited thereto and may be implemented as various other neural networks according to a task to be performed.

The encoder 102 may extract a first feature vector by using data in which a part the original data is damaged or removed (hereinafter, may be referred to as damaged data) when learning the main task. In addition, the encoder 102 may extract a second feature vector by using the original data as input when learning the auxiliary task.

The decoder 104 may output restored data based on the first feature vector input from the encoder 102 when learning the main. In addition, the decoder 104 may output reconstructed data based on the second feature vector input from the encoder 102 when learning the auxiliary task.

Here, the machine learning model 100a for the main task may be expressed by Equation 1 below.

\hat{X}_{Y}=D(E(Y;α);β) (Equation 1)
X: original data
Y: data in which part of original data has been damaged or removed (damaged data)
\hat{X}_{Y}: restored data
E: neural network constituting encoder
α: weight of the neural network constituting encoder
D: neural network that constituting decoder
β: weight of neural network constituting decoder

In addition, an objective function Lᵣₑₛₜₒᵣₐₜᵢₒₙ for performing the main task of the machine learning model 100a may be expressed through Equation 2 below.

Lᵣₑₛₜₒᵣₐₜᵢₒₙ=∥X−\hat{X}_{Y}∥ (Equation 2)

In Equation 2, a function ∥A−B∥ represents a function for obtaining a difference between A and B (e.g., a function for obtaining the Euclidean distance (L2 distance) or Manhattan distance (L1 distance) between A and B, etc.).

In addition, the machine learning model 100a for the auxiliary task may be expressed by Equation 3 below.

\hat{X}_{X}=D(E(X;α);β) (Equation 3)
\hat{X}_{X}: reconstructed data

And, an objective function L_{reconstruction} for performing the auxiliary task of the machine learning model 100a may be expressed through Equation 4 below.

L_{reconstruction}=∥X−\hat{X}_{X}∥ (Equation 4)

Meanwhile, optimized weights (α*, β*) of the machine learning model 100a for performing both the main task and the auxiliary task may be expressed through Equation 5 below.

α*,β*=argmin_{α,β}(Lᵣₑₛₜₒᵣₐₜᵢₒₙ+λL_{reconstruction}) (Equation 5)
λ: weight for importance between objective function of main task and objective function of auxiliary task

Here, argmin_{α,β}( ) represents a function to find α, β that minimizes ( ). Meanwhile, the machine learning model 100a may simultaneously perform the auxiliary task in addition to the main task, or alternately perform the main task and the auxiliary task. In Equation 5, λ may be replaced with a ratio of the number of learning times of the main task and the auxiliary task. That is, the machine learning model 100a may adjust the ratio of the number of learning times of the main task and the auxiliary task so that the sum of the objective function of the main task and the objective function of the auxiliary task is minimized.

FIG. 3 is a diagram schematically illustrating a device for generating data according to another embodiment of the present invention.

Referring to FIG. 3, a device for generating data 200 includes a machine learning model 200a. The machine learning model 200a is trained to receive a first type of data and generate a second type of data that is a different type from the first type from the input first type of data. That is, the machine learning model 200a may be trained to transform and output the first type of data into the second type of data. In this case, the machine learning model 200a may be trained so that the difference between the data (transformed data) transformed by the machine learning model 200a and the original data (i.e., the second type of original data) is minimized.

The machine learning model 200a may perform a task of receiving the first type of data, and transforming the first type of data into the second type of data and outputting the second type of data, as a main task. In addition, the machine learning model 200a may perform a task of receiving the second type of data (that is, data of the same type as output from the main task), and reconstructing and outputting the second type of data in the same form as the input second type of data, as an auxiliary task.

Here, when the machine learning model 200a learns the main task, the machine learning model 200a learns the error between the transformed data and the original data through backpropagation to adjust the weights of the neural network, but the forward operation is not performed on the second type of data, which is in the form of output data.

To this end, in the embodiment disclosed herein, the forward operation can also be performed on the second type of data to adjust the weight of the corresponding neural network by allowing the machine learning model 200a to further perform the auxiliary task, so that it is possible to finely transform even the detailed parts that are difficult to reproduce only by performing the main task.

For example, when the machine learning model 200a performs a task of receiving a speech signal as an input and generating a part related to utterance of a face image as the main task, the machine learning model 200a outputs a reconstructed image by attempting to fill in the shape and color of the corresponding part in a state in which the machine learning model 200a fails to extract the features of the image pattern of the mouth part)

Here, when the machine learning model 200a additionally performs the auxiliary task of receiving a face image in which the part related to utterance is intact, extracting image features from the input face image (image features are also extracted for the mouth part), and then outputting a reconstructed image reconstructed from the face image, the forward operation for extracting image features is also performed for the part related to utterance and the weights of the neural network are trained, so that the purpose intended to be performed through the main task can be performed more effectively.

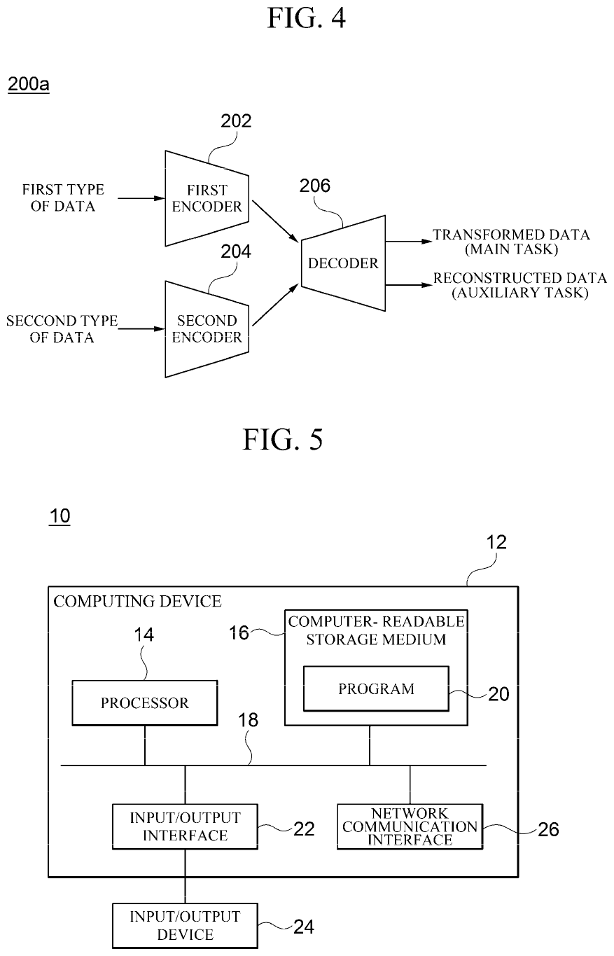

FIG. 4 is a diagram schematically illustrating a neural network for performing a main task and an auxiliary task of the device for generating data according to another embodiment of the present invention.

Referring to FIG. 4, the machine learning model 200a may include a first encoder 202, a second encoder 204, and a decoder 206. In an exemplary embodiment, the machine learning model 200a may be a convolutional neural network (CNN)-based machine learning model, but is not limited thereto, and may be implemented with various neural networks other than that according to the task to be performed.

The first encoder 202 may extract the first feature vector by using the first type of data as input when learning the main task. The second encoder 204 may extract the second feature vector by using the second type of data as input when learning the auxiliary task.

The decoder 206 may output the second type of data (transformed data) based on the first feature vector input from the first encoder 202 when learning the main task. the decoder 206 may output the second type of data (reconstructed data) based on the second feature vector input from the second encoder 204 when learning the auxiliary task input.

Here, the machine learning model 200a for the main task may be expressed through Equation 6 below.

\hat{X}_{Y}=D(E₁(Y;α);β) (Equation 6)
X: second type of data
Y: first type of data
\hat{X}_{Y}: transformed data
E₁: neural network constituting first encoder
α: weight of neural network constituting first encoder
D: neural network constituting decoder
β: weight of neural network constituting decoder

And, an objective function L_{transformation} for performing the main task of the machine learning model 200a may be expressed through Equation 7 below.

L_{transformation}=∥X−\hat{X}_{X}∥ (Equation 7)

In addition, the machine learning model 200a for the auxiliary task may be expressed through Equation 8 below.

\hat{X}_{X}=D(E₂(X;γ);β) (Equation 8)
E₂: neural network constituting second encoder
γ: weight of neural network constituting second encoder
\hat{X}_{X}: reconstructed data

And, an objective function L_{reconstruction} for performing the auxiliary task of the machine learning model 200a may be expressed through Equation 9 below.

L_{reconstruction}=∥X−\hat{X}_{X}∥ (Equation 9)

Meanwhile, optimized weights (α*, β*, γ*) of the machine learning model 200a for performing both the main task and the auxiliary task may be expressed through Equation 10 below.

α*,β*,γ*=argmin_{α,β,γ}(L_{transformation}+λL_{reconstruction}) (Equation 10)
λ: weight for importance between objective function of main task and objective function of auxiliary task

Here, argmin_{α,β,γ}( ) represents a function to find α, β, γ that minimizes ( ). Meanwhile, the machine learning model 200a may simultaneously perform the auxiliary task in addition to the main task, or alternately perform the main task and the auxiliary task. In Equation 10, λ may be replaced with a ratio of the number of learning times of the main task and the auxiliary task. That is, the machine learning model 200a may adjust the ratio of the number of learning times of the main task and the auxiliary task so that the sum of the objective function of the main task and the objective function of the auxiliary task is minimized.

FIG. 5 is a block diagram illustratively describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In an embodiment, the computing device 12 may be the device for generating data 100 or 200.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

Although representative embodiments of the present invention have been described in detail, those skilled in the art to which the present invention pertains will understand that various modifications may be made thereto within the limits that do not depart from the scope of the present invention. Therefore, the scope of rights of the present invention should not be limited to the described embodiments, but should be defined not only by claims set forth below but also by equivalents to the claims.

1: A computing device provided with one or more processors and a memory storing one or more programs executed by the one or more processors, the computing device comprising:
a machine learning model,
wherein the machine learning model is trained to perform a task of receiving data in which a part of original data is damaged or removed, and restoring and outputting the damaged or removed data part as a main task, and is trained to perform a task of receiving original data and reconstructing and outputting the received original data as an auxiliary task.

2: The computing device according to claim 1, wherein the machine learning model includes:
an encoder configured to:
extract a first feature vector by using data in which a part of the original data is damaged or removed as input when learning the main task; and
extract a second feature vector by using the original data as input when learning the auxiliary task; and
a decoder configured to:
output restored data based on the first feature vector input from the encoder when learning the main task; and
output reconstructed data based on the second feature vector input from the encoder input when learning the auxiliary task.

3: The computing device according to claim 2, wherein
the machine learning model for the main task is expressed by Equation 1 below:
\hat{X}_{Y}=D(E(Y;α);β) [Equation 1]; and
an objective function Lᵣₑₛₜₒᵣₐₜᵢₒₙ for performing the main task may be expressed by Equation 2 below:
Lᵣₑₛₜₒᵣₐₜᵢₒₙ=∥X−\hat{X}_{Y}∥ [Equation 2]
Y: data in which part of original data has been damaged or removed;
\hat{X}_{Y}: restored data;
E: neural network constituting encoder;
α: weight of the neural network constituting encoder;
D: neural network that constituting decoder; and
β: weight of neural network constituting decoder.

4: The computing device according to claim 3, wherein
the machine learning model for the auxiliary task is expressed by Equation 3 below:
\hat{X}_{X}=D(E(X;α);β) [Equation 3]; and
an objective function L_{reconstruction} for performing the auxiliary task is expressed by Equation 4 below:
L_{reconstruction}=∥X−\hat{X}_{X}∥ [Equation 4)
where, \hat{X}_{X}: reconstructed data.

5: The computing device according to claim 4, wherein optimized weights (α*, β*) of the machine learning model for performing both the main task and the auxiliary task are expressed through Equation 5 below:
α*,β*=argmin_{α,β}(Lᵣₑₛₜₒᵣₐₜᵢₒₙ+λL_{reconstruction}) [Equation 5)
where λ is weight for importance between objective function of main task and objective function of auxiliary task.

6: The computing device according to claim 4, wherein the machine learning model adjusts a ratio of the number of learning times of the main task and the auxiliary task so that a sum of the objective function of the main task and the objective function of the auxiliary task is minimized.

7: A computing device provided with one or more processors and a memory storing one or more programs executed by the one or more processors, the computing device comprising:
a machine learning model,
wherein the machine learning model is trained to perform a task of receiving a first type of data, and transforming and outputting the first type of data into a second type of data that is different from the first type as a main task, and is trained to perform a task of receiving a second type of data, which is the same type as that output from the main task, and reconstructing and outputting the received second type of data as an auxiliary task.

8: The computing device according to claim 7, wherein the machine learning model includes:
a first encoder that extracts a first feature vector by using the first type of data as input when learning the main task;
a second encoder that extracts a second feature vector by using the second type of data as input when learning the auxiliary task; and
a decoder that outputs transformed data based on the first feature vector input from the first encoder when learning the main task, and outputs reconstructed data based on the second feature vector input from the second encoder input when learning the auxiliary task.

9: The computing device according to claim 8, wherein the machine learning model for the main task is expressed by Equation 6 below:
\hat{X}_{Y}=D(E₁(Y;α);β) [Equation 6]; and
an objective function L_{transformation} for performing the main task is expressed by Equation 7 below:
L_{transformation}=∥X−\hat{X}_{X}∥ [Equation 7]
where, X: second type of data;
Y: first type of data;
\hat{X}_{Y}: transformed data;
E₁: neural network constituting first encoder;
α: weight of neural network constituting first encoder;
D: neural network constituting decoder; and
β: weight of neural network constituting decoder.

10: The computing device according to claim 9, wherein the machine learning model for the auxiliary task is expressed by Equation 8 below:
\hat{X}_{X}=D(E₂(X;γ);β) [Equation 8]; and
an objective function L_{reconstruction} for performing the auxiliary task is expressed by Equation 9 below:
L_{reconstruction}=∥X−\hat{X}_{X}∥ [Equation 9)
where E₂: neural network constituting second encoder;
γ: weight of neural network constituting second encoder; and
\hat{X}_{X}: reconstructed data.

11: The computing device according to claim 10, wherein optimized weights (α*, β*, γ*) of the machine learning model for performing both the main task and the auxiliary task are expressed through Equation 10 below:
α*,β*,γ*=argmin_{α,β,γ}(L_{transformation}+λL_{reconstruction}) [Equation 10]
where λ: weight for importance between objective function of main task and objective function of auxiliary task.

12: The computing device according to claim 10, wherein the machine learning model adjusts a ratio of the number of learning times of the main task and the auxiliary task so that a sum of the objective function of the main task and the objective function of the auxiliary task is minimized.

13: A method performed in a computing device provided with one or more processors and a memory storing one or more programs executed by the one or more processors, the method comprising:
an operation of being trained to perform a task of receiving data in which a part of original data is damaged or removed, and restoring and outputting the damaged or removed data part as a main task, in the machine learning model; and
an operation of being trained to perform a task of receiving original data and reconstructing and outputting the received original data as an auxiliary task, in the machine learning model.

14: A method performed in a computing device provided with one or more processors and a memory storing one or more programs executed by the one or more processors, the method comprising:
an operation of being trained to perform a task of receiving a first type of data, and transforming and outputting the first type of data into a second type of data that is different from the first type as a main task, in the machine learning model; and
an operation of being trained to perform a task of receiving a second type of data, which is the same type as that output from the main task, and reconstructing and outputting the received second type of data as an auxiliary task, in the machine learning model.
